(19) United States
(12) Patent Application Publication
(10) Pub. No.: US 2015/0073866 A1
(43) Pub. Date: Mar. 12, 2015

(54) DATA VISUALIZATION AND USER INTERFACE FOR MONITORING RESOURCE ALLOCATION TO CUSTOMERS

(71) Applicant: Oracle International Corporation, Redwood Shores, CA (US)

(72) Inventors: Bao Liu, Santa Clara, CA (US); Jeffrey Pease, San Francisco, CA (US); Dave Stephens, Half Moon Bay, CA (US); Heather Weir, Sunnyvale, CA (US); Miguel Aramis Ramirez Ibarra, La Calma (MX); Jesus Eduardo Urias Barrientos, Redwood Shores, CA (US)

(73) Assignee: Oracle International Corporation, Redwood Shores, CA (US)

(21) Appl. No.: 14/025,746

(22) Filed: Sep. 12, 2013

(51) Int. Cl. G06Q 30/02

(52) U.S. Cl. CPC G06Q 30/0202
USPC 705/7.31

(57) ABSTRACT

Data visualizations and user interfaces help managers identify promising deals requiring additional attention as well as other deals receiving a disproportionate amount of effort relative to their expected return. A deal forecast visualization positions deal icons at a distance from an origin point based on deal attribute values of associated pending deals. Deal icons may be positioned based on deal attributes including deal activity levels and expected closing dates. Deal attribute values may be retrieved from a CRM application. Visual indicators may provide additional information about pending deals. Deal icons may be scaled, colored, and/or shaded based on one or more attribute values of their respective pending deals. Additionally, the data visualization may be partitioned into circular segments, with each segment enclosing related deal icons and having an angular size based on the aggregate value of an attribute of the enclosed deal icons.

### CROSS REFERENCES TO RELATED APPLICATIONS

This application is related to the following applications, Attorney Docket Number-ORACP0103, U.S. patent application Ser. No ______, entitled DATA VISUALIZATION AND USER INTERFACE FOR MONITORING AND PREDICTION OF DEAL PERFORMANCE, filed on Sep. 12, 2013, and Attorney Docket. Number-ORACP0104, U.S. patent application Ser. No. ______, entitled DEAL STAGE DATA VISUALIZATION AND USER INTERFACE, filed on. Sep. 12, 2013, which are hereby incorporated by reference, as if set forth in full in this specification.

### BACKGROUND

This application relates to the field of user interfaces for visualizing and forecasting deal and other enterprise data. Customer Relation Management (CRM) applications are intended to organize and automate interactions between an organization's representatives, such as salespeople, and the organization's customers and potential customers. CRM applications can assist organizations with managing interactions with customers and potential customers in a number of different ways.

Monitoring the activity of salespeople on deals is one task typically performed by CRM applications. Deal managers may view the data collected by CRM applications to monitor the activities of their salespeople. One task for managers is to effectively utilize salespeople to maximize returns to the organization. To maximize returns to the organization, it is important for managers to be able to identify promising deals that require more attention from salespeople as well as opportunities that are consuming a disproportionate amount of effort relative to their expected return.

Unfortunately, current CRM applications do not make it easy for deal managers to identify opportunities in need of attention. Current CRM applications often present deal activity data in a tabular format and require deal managers to sort and manually analyze columns of data to identify promising deals requiring additional attention as well as other deals receiving a disproportionate amount of effort relative to their expected return.

### SUMMARY

An embodiment of the invention includes a set of data visualizations and user interfaces adapted to help deal managers identify promising deals requiring additional attention as well as other deals receiving a disproportionate amount of effort relative to their expected return.

An embodiment of the set of data visualizations and user interfaces includes a deal forecast visualization that partitions a presentation area along a radial axis from an origin point. In one example, the presentation area may be a circle or other similar shape. Deal icons are positioned at a distance from the origin point based on a value of a deal attribute of the associated pending deal. Each deal icon represents an individual pending deal.

In one embodiment, deal icons are positioned at distances from the origin point based on the activity levels associated with the corresponding pending deals. In another embodiment, deal icons are positioned at distances from the origin point based on the expected closing dates associated with the corresponding pending deals. Regardless of the type of deal attribute used to position deal icons, embodiments of the invention may retrieve deal attribute values from a CRM application.

Further embodiments of the invention may provide additional information about pending deals using visual indicators. For example, deal icons may be scaled based on the values of their respective pending deals. In another example, deal icons may be colored or shaded based on a category value associated with its respective pending deal. Examples of category values include deal region, product category, management group, deal group, industry segment, and/or market segment. In still an additional example, the presentation area may be partitioned into circular segments, with each segment enclosing related deal icons and having an angular size based on the aggregate value of an attribute of the enclosed deal icons.

A further understanding of the nature and the advantages of particular embodiments disclosed herein may be realized by reference of the remaining portions of the specification and the attached drawings.

### BRIEF DESCRIPTION OF THE DRAWINGS

The invention will be described with reference to the drawings, in which:

FIG. 1 illustrates an example data visualization and user interface according to an embodiment of the invention;

FIG. 2 illustrates an example first detail view of the data visualization and user interface according to an embodiment of the invention;

FIG. 3 illustrates an example second detail view of the data visualization and user interface according to an embodiment of the invention;

FIG. 4 illustrates an example alternate data visualization and user interface according to an embodiment of the invention; and

FIG. 5 illustrates an example system suitable for implementing embodiments of the invention.

### DETAILED DESCRIPTION OF EMBODIMENTS

An embodiment of the invention includes a set of data visualizations and user interfaces adapted to help deal managers identify promising deals requiring additional attention as well as other deals receiving a disproportionate amount of effort relative to their expected return.

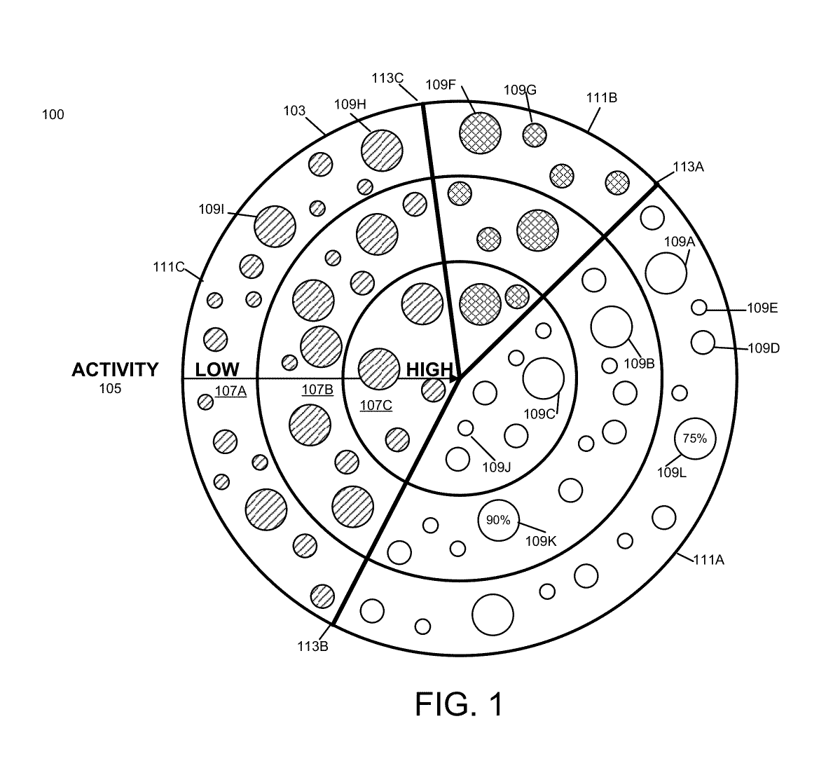

FIG. 1 illustrates an example data visualization and user interface 100 according to an embodiment of the invention. Example 100 includes a circular presentation area 103. Although shown as a circular shape in example 100, other embodiments may use presentation areas of other shapes. Circular presentation area 103 includes a visual arrangement of circular icons 109 representing individual deals.

In an embodiment, the deal icons 109 are arranged on a radial axis 105 that, in this example 100, represents deal activity level. Deals with higher activity levels, such as more phone calls, e-mails, meetings, or other contacts, have their icons positioned closer to the center or other origin point of the circular presentation area 103, while deals with lower activity levels have their icons positioned closer to the outer edge of the circular presentation area 103. For example, deal icons 109A, 109B, and 109C represent deals with increasing levels of activity, respectively.

In one embodiment, deal activity levels may be categorized into two or more discrete levels. For example, radial axis 105 is divided into three discrete levels representing low 107A, medium 107B, and high 107C levels of activity. In an alternate embodiment, activity levels may be represented as a range of continuous values along radial axis 105.

In an embodiment, activity levels may be derived from the activity information recorded by a CRM application. In other embodiments, other applications may provide this information or users may enter this information manually.

Additionally, an embodiment of the invention scales the size of deal icons 109 relative to their potential value, such as the estimated total monetary value of the potential sale. For example, deal icons 109A, 109D, and 109E represent potential deal with high, medium, and low expected monetary value, respectively. In an embodiment, deal icons 109 are restricted to two or more discrete sizes and each deal is assigned to one of the available icon sizes based on its absolute or relative value. In an alternate embodiment, deal icons may have any size between a minimum and maximum icon size based on their relative values.

In an embodiment, deal icons 109 may be assigned color or shading based on their membership in one or more categories. For example, deal icons may be colored or shaded to indicate their membership in a specific deal region, product category, management or deal group, industry or market segment, or any other category associated with the deal, the organization, or the potential customer. For example, deal icons 109A-109E are shaded similarly to indicate their association with a first management unit; deal icons 109F and 109G are shaded similarly to indicate their association with a second management unit; and deal icons 109H and 109I are shaded similarly to indicate their association with a third management unit. Embodiments of the invention may utilize any number of categories as applicable to the data under analysis and the three categories shown in this example are for the purposes of illustration and not to limit the scope of the invention.

In addition to the shading or coloring of individual deal icons 109, an embodiment of the invention also groups related deal icons together in circular sectors 111. Radial dividing lines 113 may also be added to delineate the boundaries between circular sectors. For example, the semi-circular region 111A between dividing lines 113A and 113B includes deal icons associated with a first management unit. Similarly, semi-circular region 111B between dividing lines 113A and 113C includes deal icons associated with a second management unit and semi-circular region 111C between dividing lines 113B and 113C includes deal icons associated with a third management unit.

In yet a further embodiment, the sizes of the semi-circular regions 111 including related deal icons are scaled based on the total value of their respective deals. In this embodiment, the semi-circular regions 111 convey information in a similar manner as a pie chart about the aggregate value of deals in each category, while simultaneously displaying the size and activity level of individual pending deal.

Each deal may be assigned a deal win probability, reflecting the likelihood that the organization will succeed in receiving in deal. Deal win probabilities may be determined by statistical analysis using CRM or other software applications, by evaluation of one or more users, by the application of heuristics, or by any other analysis technique known in the art.

In another embodiment, the deal win probability may be displayed as text or a graphical indicator within some or all of the deal icons. For example, deal icons 109K and 109L include text indicators of the deal win probability. In still another embodiment, deal win probabilities may be hidden on some or all of the deal icons to prevent cluttering the data visualization until this information is requested by the user. In yet another embodiment, the deal win probability information may be displayed on deal icons when the user enlarges or zooms in on a portion of the circular presentation area 103.

The example data visualization and user interface 100 enables deal managers to easily visually identify promising deals requiring additional attention as well as other deals receiving a disproportionate amount of effort relative to their expected return. For example, large deal icons located near the outer edge of the circular presentation area 103, such as deal icon 109A, represent high-value deals that have received little activity from salespersons. Upon seeing these types of icons, a manager may choose to direct the responsible salesperson to devote more effort on this deal. Conversely, small deal icons located near the center of the circular presentation area 103, such as deal icon 109J, represent low-value deals consuming a large amount of salesperson activity. Upon seeing these types of icons, a manager may choose to direct the responsible salesperson to focus on other, potentially larger opportunities.

In yet a further embodiment, a user may apply one or more filters to expand or restrict the number and/or type of deals presented in this data visualization and user interface. Example filters include deal sizes, time frames, specific deal region, product category, management or deal group, industry or market segment, or any other category associated with the deal, the organization, or the potential customer. Filters may be enabled, disabled, and configured through the use of menu items, user interface buttons, and/or any other types of user interface input widgets or elements known in the art.

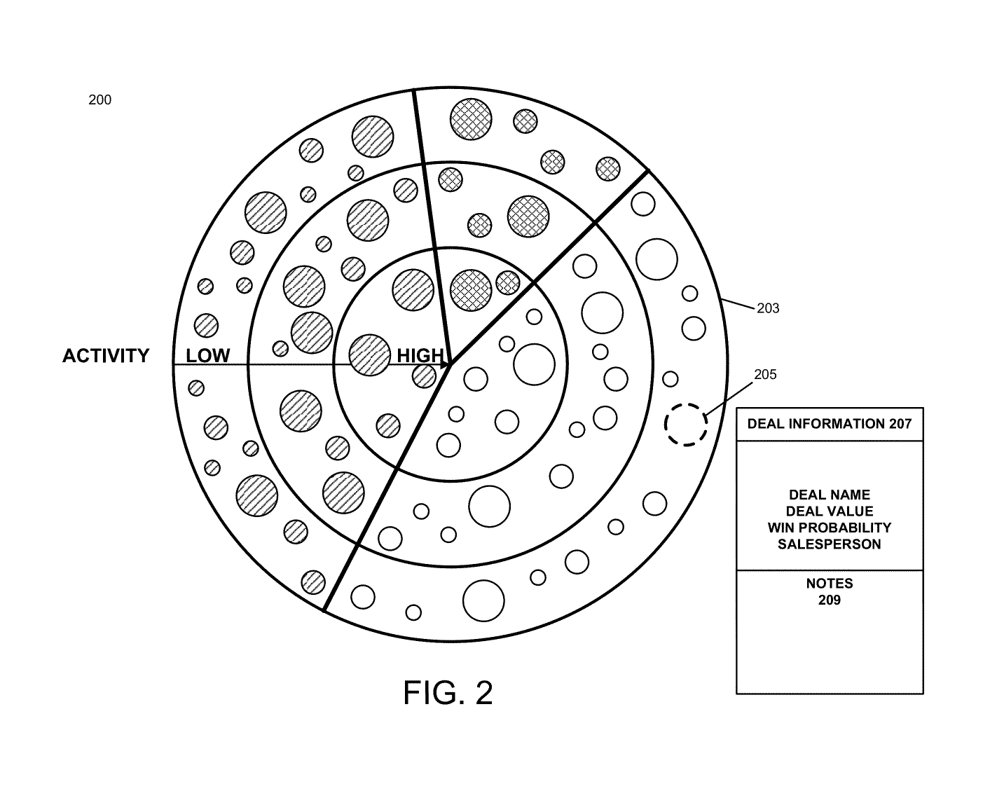

In addition to viewing information about deals as described in example 100, a further embodiment of the invention provides detailed information on specific deals. FIG. 2 illustrates an example first detail view 200 of the data visualization and user interface according to an embodiment of the invention.

Example 200 includes a circular presentation area 203 and deals icons, similar to example 100 discussed above. Upon receiving a user selection of one or more of the deal icons, example 200 presents additional information about this specific deal in a panel or window. For example, if a user selects deal icon 205, panel 207 will be displayed with additional information about this associated deal.

Examples of additional deal information include, but are not limited to: the deal name, the deal value, the deal win probability, the responsible salesperson or team, the length that the deal has been pending, the sales stage that the deal is in, the amount of time that the deal has been in its current sales stage, the deal forecast, the estimated deal close date, potential deal competitors, and the status of the deal.

In a further embodiment, the panel 207 may include an area 209 for the user to enter notes about the deal. In yet a further embodiment, these notes may be recorded in a CRM or other application and/or distributed to other individuals or groups associated with the selected deal.

In an embodiment, a user may tap an icon to dismiss panel 207 or a different deal icon to view its deal information.

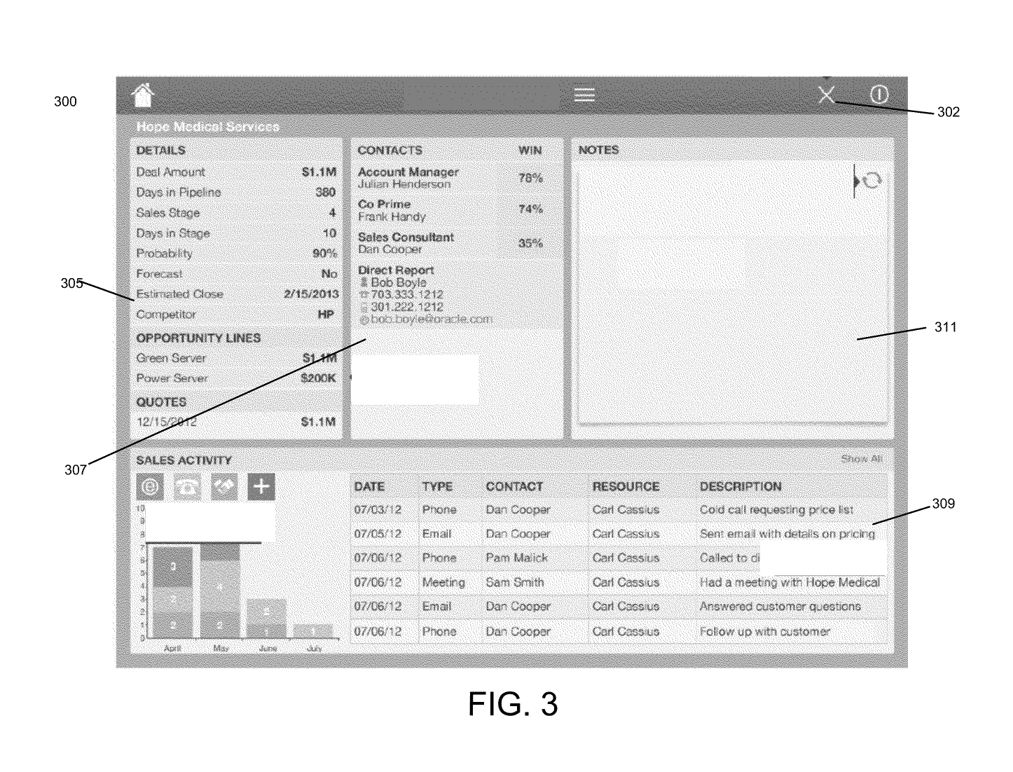

FIG. 3 illustrates an example second detail view 300 of the data visualization and user interface according to an embodiment of the invention. In an embodiment, the second detail view 300 may be displayed with a user selects an icon in a panel 207 for a selected deal in detail view 200. Selecting an icon 302 in the second detail view 300 closes this view and returns to detail view 200 or the data presentation example 100.

In the second detail view 300, a user may view addition specific information about the pending deal, including a summary of the deal information 305, deal contact information 307, recent activity associated with the deal 309, and notes 311 about the deal. Notes 311 may be edited, added, saved to a CRM or other application, and/or distributed to other users via this view. Deal information may be displayed in detail view 300 in tabular and/or graphical format. Scrolling, filtering, searching, and/or sorting functions may also be included to assist users in retrieving information about the deal.

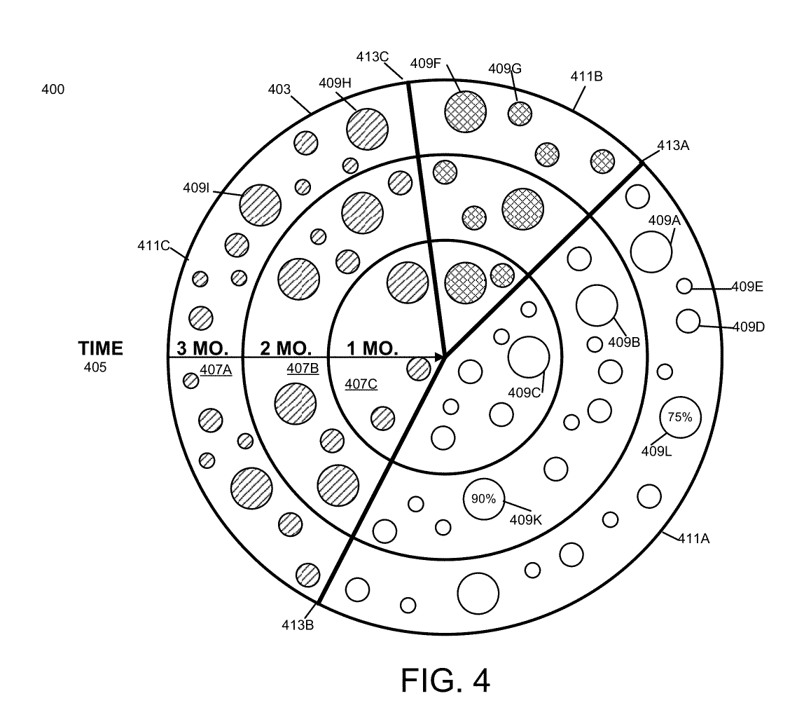

FIG. 4 illustrates an example alternate data visualization and user interface 400 according to an embodiment of the invention. Example data visualization and user interface 400 is similar to the example 100 shown above, except the radial axis represents time until expected deal closing, rather than deal activity level.

Example 400 includes a circular presentation area 403 including a circular presentation area 403. The circular presentation area 403 includes a visual arrangement of circular icons 109 representing individual deals. The deal icons 409 are arranged on a radial axis 405 that, in this example 400, represents the time until expected closing dates of the deals. Deals expected to close sooner have their icons positioned closer to the center of the circular presentation area 403, while deals with later expected closing dates have their icons positioned closer to the outer edge of the circular presentation area 403. For example, deal icons 409A, 409B, and 409C represent deals with expected closing dates closer to the present date, respectively.

In one embodiment, deal closing dates may be categorized into two or more discrete levels. For example, radial axis 405 is divided into three discrete levels representing closing dates two to three months away 107A, one to two months away 407B, and less than one month away 407C. In an alternate embodiment, closing dates may be represented as a range of continuous values along radial axis 405.

In an embodiment, activity levels may be derived from the activity information recorded by a CRM application. In other embodiments, other applications may provide this information or users may enter this information manually.

Additionally, as in example 100, an embodiment of the invention scales the size of deal icons 409 relative to their potential value, such as the estimated total monetary value of the potential sale. For example, deal icons 409A, 409D, and 409E represent potential deal with high, medium, and low expected monetary value, respectively. Embodiments of the invention may represent deal sizes as two or more discrete sizes of icons or as icons of any size between a minimum and maximum icon size based on their relative values.

In an embodiment, deal icons 409 may be assigned color or shading based on their membership in one or more categories, such as a deal region, product category, management or deal group, industry or market segment, or any other category associated with the deal, the organization, or the potential customer. For example, deal icons 409A-409E are shaded similarly to indicate their association with a first management unit; deal icons 409F and 409G are shaded similarly to indicate their association with a second management unit; and deal icons 409H and 409I are shaded similarly to indicate their association with a third management unit.

In addition to the shading or coloring of individual deal icons 409, an embodiment of the invention also groups related deal icons together in circular sectors 411, with radial dividing lines 413 optionally added to delineate the boundaries between circular sectors. For example, the semi-circular region 411A between dividing lines 413A and 413B includes deal icons associated with a first management unit. Similarly, semi-circular region 411B between dividing lines 413A and 413C includes deal icons associated with a second management unit and semi-circular region 411C between dividing lines 413B and 413C includes deal icons associated with a third management unit.

In yet a further embodiment, the sizes of the semi-circular regions 411 including related deal icons are scaled based on the total value of their respective deals. In this embodiment, the semi-circular regions 411 convey information in a similar manner as a pie chart about the aggregate value of deals in each category, while simultaneously displaying the size and activity level of individual pending deal.

Each deal may be assigned a deal win probability, reflecting the likelihood that the organization will succeed in receiving in deal. Deal win probabilities may be determined by statistical analysis using CRM or other software applications, by evaluation of one or more users, by the application of heuristics, or by any other analysis technique known in the art.

In another embodiment, the deal win probability may be displayed as text or a graphical indicator within some or all of the deal icons. For example, deal icons 109K and 109L include text indicators of the deal win probability. In still another embodiment, deal win probabilities may be hidden on some or all of the deal icons to prevent cluttering the data visualization until this information is requested by the user. In yet another embodiment, the deal win probability information may be displayed on deal icons when the user enlarges or zooms in on a portion of the circular presentation area 403.

The example data visualization and user interface 400 enables deal managers to easily visually identify promising deals that are near closing. For example, a deal manager may have a monthly or quarterly sales quota to meet. In this situation, the example data visualization 400 provides deal managers with a view of deals that are near closing and may be able to be accelerated to meet the sales quota. Additionally, the example data visualization and user interface 400 enables deal managers to view the set of deals expected to close in the near future and identify any potential shortfalls far enough in advance to take corrective action.

In yet a further embodiment, a user may apply one or more filters to expand or restrict the number and/or type of deals presented in this data visualization and user interface 400. Example filters include deal sizes, time frames, specific deal region, product category, management or deal group, industry or market segment, or any other category associated with the deal, the organization, or the potential customer.

Example data visualization and user interface 400 may also present detailed deal information to users, for example using interfaces similar to those shown in examples 200 and 300.

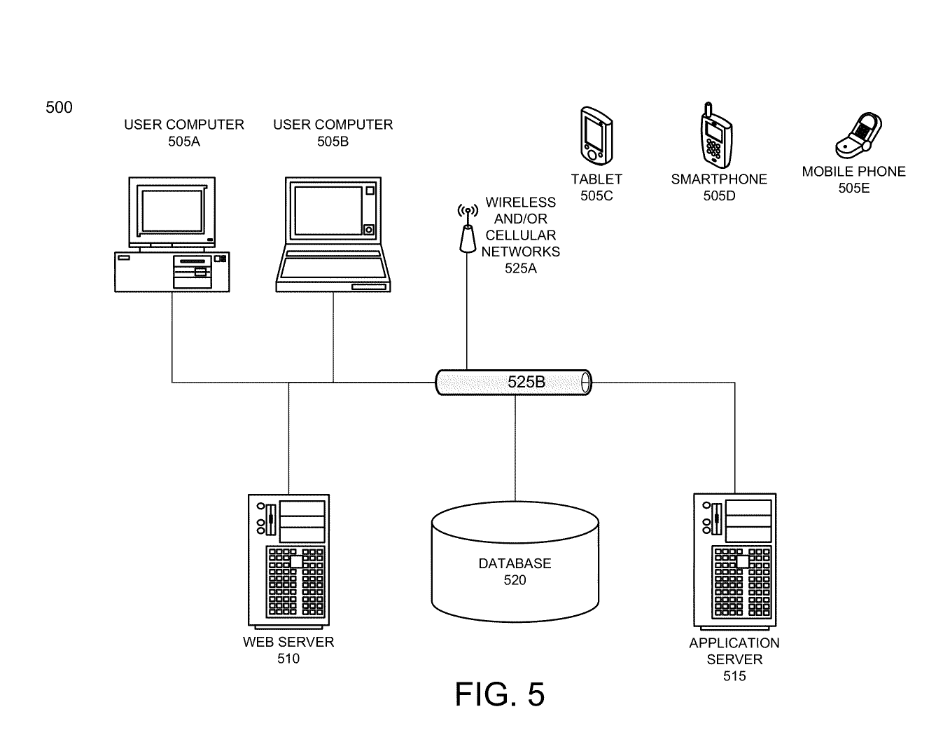

FIG. 5 illustrates an example system 500 suitable for implementing embodiments of the invention. Embodiments of the invention may be implemented as standalone applications or as web-based applications implemented using a combination of client-side and server-side code. FIG. 5 shows an example computer and network system architecture 500 suitable for implementing embodiments of the invention. The system includes user computers 505 including desktop 505A and portable personal computers 505B, tablets 505C, smartphones 505D, and mobile phones 505E. The system can interface with any type of electronic device, such as a thin-client computer, Internet-enabled mobile telephone, mobile Internet access device, tablet, electronic book, or personal digital assistant, capable of displaying and navigating web pages or other types of electronic documents and/or executing applications. Although the system 500 is shown with five user computers, any number of user computers can be supported.

A web server 510 is used to process requests from web browsers and standalone applications for web pages, electronic documents, enterprise data or other content, and other data from the user computers. The server 510 may also provide the menu application, as well as syndicated content, such as RSS feeds, of data related to enterprise operations.

Application server 515 operates one or more mobile applications. The mobile applications can be implemented as one or more scripts or programs written in any programming language, such as Java, C, C++, C#, or any scripting language, such as JavaScript or ECMAScript, Perl, PHP, Python, Ruby, or TCL. Data applications can be built using libraries or application frameworks, such as Rails, Enterprise JavaBeans, or .NET.

The data applications on application server 515 process input data and user computer requests and can store or retrieve data from database 520. Database 520 stores data created and used by the data applications. In an embodiment, the database 520 is a relational database that is adapted to store, update, and retrieve data in response to SQL format commands or other database query languages. In other embodiments, unstructured data storage architectures and NoSQL databases may also be used.

In an embodiment, the application server 515 is one or more general-purpose computers capable of executing programs or scripts. In an embodiment, the web server 510 is implemented as an application running on one or more general-purpose computers. The web server and application server may be combined and executed on the same computers.

An electronic communication network 525 enables communication between user computers 505, web server 510, application server 515, and database 520. In an embodiment, network 525 may further include any form of electrical or optical communication devices, including wireless 525A and wired 525B networks. Network 525 may also incorporate one or more local-area networks, such as an Ethernet network; wide-area networks, such as the Internet and cellular carrier data networks; and virtual networks, such as a virtual private network.

The system is one example for executing mobile applications according to an embodiment of the invention. In another embodiment, application server, web server, and optionally database can be combined into a single server computer application and system. In a further embodiment, virtualization and virtual machine applications may be used to implement one or more of the application server, web server, and database. In still further embodiments, all or a portion of the web server and application functions may be integrated into an application running on each of the user computers. For example, a JavaScript application on the user computer may be used to retrieve or analyze data and display portions of the applications.

Although the description has been described with respect to particular embodiments thereof, these particular embodiments are merely illustrative, and not restrictive. Any suitable programming language can be used to implement the routines of particular embodiments. Any type of programming techniques may be employed including procedural, functional, and/or object oriented programming techniques. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a computer-readable storage medium for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

We claim:

1. A method of presenting deal forecast information, the method comprising:
generating a deal forecast visualization including:
a first partitioning of a presentation area along a radial axis from an origin point;
deal icons, wherein each deal icon represents an individual pending deal, wherein each deal icon is positioned at a distance from the origin point based on a value of a deal attribute of the associated pending deal; and
providing the deal forecast visualization for display by an electronic device.

2. The method of claim 1, wherein the deal attribute includes an activity level associated with the pending deal.

3. The method of claim 1, wherein the deal attribute includes an expected deal closing date associated with the pending deal.

4. The method of claim 1, wherein the value of the deal attribute of the associated pending deal is retrieved from a CRM application.

5. The method of claim 1, wherein each deal icon is scaled based on a value of its respective pending deal.

6. The method of claim 1, wherein each deal icon is colored or shaded based on a category value associated with its respective pending deal.

7. The method of claim 6, wherein the category value belongs to at least one category including deal region, product category, management group, deal group, industry segment, and/or market segment.

8. The method of claim 1, comprising:
receiving at least one user input selecting a first one of the deal icons; and
in response to the user input, generating a display of additional deal information from its respective pending deal.

9. The method of claim 1, comprising:
receiving at least one user input specifying at least one filtering parameter; and
in response to the user input, removing at least a portion of the deal icons from the deal forecast visualization that do not satisfy the filtering parameter.

10. The method of claim 1, wherein generating the deal forecast visualization includes:
a second partitioning of the presentation area into circular sectors, wherein each circular sector is associated with a category value, encloses deal icons associated with pending deals matching the category value, and has an angular size based on an aggregate value of a second deal attribute of the included deal icons.

11. A tangible, computer-readable information storage medium including instructions adapted to direct a computer to display a user interface, the user interface comprising:
a deal forecast visualization including a presentation area partitioned along a radial axis from an origin point; and
deal icons, wherein each deal icon represents an individual pending deal, wherein each deal icon is positioned at a distance from the origin point based on a value of a deal attribute of the associated pending deal.

12. The tangible, computer-readable information storage medium of claim 11, wherein the deal attribute includes an activity level associated with the pending deal.

13. The tangible, computer-readable information storage medium of claim 11, wherein the value of the deal attribute of the associated pending deal is retrieved from a CRM application.

14. The tangible, computer-readable information storage medium of claim 11, wherein each deal icon is scaled based on a value of its respective pending deal.

15. The tangible, computer-readable information storage medium of claim 11, wherein each deal icon is colored or shaded based on a category value associated with its respective pending deal.

16. The tangible, computer-readable information storage medium of claim 15, wherein the category value belongs to at least one category including deal region, product category, management group, deal group, industry segment, and/or market segment.

17. The tangible, computer-readable information storage medium of claim 11, comprising:
a deal detail user interface input for receiving a user input and generating a display of additional deal information associated with a selected one of the deal icons in response to the user input.

18. The tangible, computer-readable information storage medium of claim 11, comprising:
a deal filtering user interface input for receiving a user input specifying at least one filtering parameter; and in response to the user input, for removing at least a portion of the deal icons from the deal forecast visualization that do not satisfy the filtering parameter.

19. The tangible, computer-readable information storage medium of claim 11, wherein the user interface including the deal forecast visualization comprises:
a second partitioning of the presentation area into circular sectors, wherein each circular sector is associated with a category value, encloses deal icons associated with pending deals matching the category value, and has an angular size based on an aggregate value of a second deal attribute of the included deal icons.

20. A system comprising:
a client system;
a database storing pending deal data; and
an application server connected with the database and the client system via at least one network, wherein the application server is adapted to retrieve the deal data from the database and communicate the retrieved deal data with the client system;
wherein the client system includes an application including instructions executable by the client system to perform a method, the method comprising:
generating a deal forecast visualization including:
a first partitioning of a presentation area along a radial axis from an origin point;
deal icons, wherein each deal icon represents an individual pending deal, wherein each deal icon is positioned at a distance from the origin point based on a value of a deal attribute of the associated pending deal; and
providing the deal forecast visualization for display by an electronic device.
